(19) United States
(12) Patent Application Publication
(10) Pub. No.: US 2014/0290358 A1
(43) Pub. Date: Oct. 2, 2014

(54) CHEMICAL MEASURING DEVICE

(71) Applicant: Peter Eiselt, Aurora, CO (US)

(72) Inventor: Peter Eiselt, Aurora, CO (US)

(21) Appl. No.: 13/855,140

(22) Filed: Apr. 2, 2013

(51) Int. Cl. G01F 23/00

(52) U.S. Cl. CPC G01F 23/0038
USPC 73/322.5

(57) ABSTRACT

The present invention relates to a liquid level measuring system comprising: a liquid container; a measuring stick immersed into the liquid container; and a buoyancy ball attached to the immersed end of the measuring stick. The measuring stick may include numerical markers indicating the liquid level within the liquid container. The liquid level measuring system may also include a threaded cap, where the threaded cap receives the measuring stick for insertion into the liquid container.

### BACKGROUND OF THE INVENTION

1. Field of Invention

The present invention relates to a chemical measuring device that provides an effective means to measure the level of liquids within a container.

2. Description of Related Art

It is necessary to measure the liquid level within various containers throughout various industries. Many times if an electronic or internal mechanism is utilized to measure the level of liquid in a container or a dipstick may be normally used to insert in the container to provide an estimation of the liquid remaining in the container. Many times this stick is simply lowered into the container until it touches the bottom and then a series of numbers or notches are provided on the stick to determine the volume of liquid within the container. Occasionally this method of measuring liquids may lend itself to human error if the stick is not completely depressed in the container or other factors related to the human intervention may cause errors in the measurement. It would be advantageous to have a device that simply provides a complete visual measurement of liquids in a container without any necessity for a human to insert a dipstick or other type of measuring stick in the container.

### SUMMARY OF THE INVENTION

The present invention relates to a liquid level measuring system and method comprising: a liquid container; a measuring stick immersed into the liquid container; and a buoyancy ball attached to the immersed end of the measuring stick. The measuring stick may include numerical markers indicating the liquid level within the liquid container. The liquid level measuring system may also include a threaded cap, where the threaded cap receives the measuring stick for insertion into the liquid container.

### BRIEF DESCRIPTION OF DRAWINGS

FIG. 1 depicts the use of a liquid measuring device in accordance with the present invention.

### DETAILED DESCRIPTION

The present invention relates to a system for measuring the level of liquids within a container that utilizes a stick that is lowered within the container with a buoyancy ball attached to an immersed end of the measuring stick. Along the length of the stick may be a series of numbers, which provide an indication of the level of liquids within the container. As the level of liquids diminish the buoyancy ball on the immersed end of the measuring stick sinks into the container and thus a further portion of the measuring stick is also immersed into the container. This phenomenon allows an individual to see along the side of the measuring stick at which level the liquids are within the enclosed container. Consequently, the buoyancy ball maintains the measuring stick at a level equal to the top level of the liquid within the container. As the level of the liquid diminishes so does the buoyancy ball and therefore the stick immerses further into the container. The numerical scale provided on one side of the stick provides an indication of the liquid volume remaining in the container. The measuring system according to the present invention therefore provides a consistent visual depiction of the liquid level within the container.

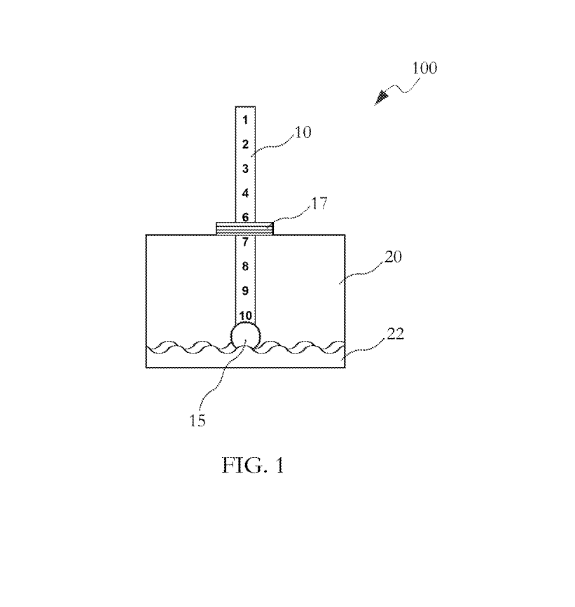

In reference to FIG. 1, a liquid measuring system 100 is depicted. The system depicted in FIG. 1 includes a liquid container 20 that includes a volume of liquid 22. The volume of liquid 22 is measured through the use of a measuring stick 10 that includes a buoyancy ball 15 at an immersed end of the measuring stick 10. The measuring stick 10 immerses into the tank through a threaded cap 17. Once the system is set up a visual depiction of the liquid volume is readily available on the measuring stick 10. The measuring stick 10 further includes a numerical scale on at least one side of the stick so that a visual depiction of the liquid level within the tank 20 is shown. As the liquid 22 increases or decreases the buoyancy ball 15 remains floating on the top surface of the liquid and therefore provides a clear indication of the liquid level on the measuring stick 10.

The liquid measuring device according to the present invention enables the individual to have accurate measurements of the liquid volume within the container without the necessity of working with a dipstick. The present invention therefore provides an easy straightforward measuring device for utilization within a closed liquid container. The instant invention has been shown and described in what it considers to be the most practical and preferred embodiments. It is recognized, however, that departures may be made there from within the scope of the invention and that obvious modifications will occur to a person skilled in the art.

What is claimed is:

1. A liquid level measuring system comprising:
a. a liquid container;
b. a measuring stick immersed into the liquid container; and
c. a buoyancy ball attached to the immersed end of the measuring stick.

2. The liquid level measuring system according to claim 1, where the stick includes numerical markers indicating the liquid level within the liquid container.

3. The liquid level measuring system according to claim 1, further including a threaded cap, where the threaded cap receives the measuring stick for insertion into the liquid container.

4. A method of measuring a liquid level in a container comprising the steps of:
a. attaching a buoyancy ball to a first end of a measuring stick;
b. placing markers along one side of the measuring stick; and
c. inserting the first end of the measuring stick into a liquid container.

5. The method of measuring a liquid level according to claim 4, where the step of inserting includes inserting the measuring stick through a threaded cap.
